(19) United States
(12) Patent Application Publication
(10) Pub. No.: US 2021/0396869 A1
(43) Pub. Date: Dec. 23, 2021

(54) SHIP DETECTION SYSTEM, METHOD, AND PROGRAM

(71) Applicant: NEC Corporation, Minato-ku, Tokyo (JP)

(72) Inventor: Kenta SENZAKI, Tokyo (JP)

(73) Assignee: NEC Corporation, Minato-ku, Tokyo (JP)

(21) Appl. No.: 17/281,333

(22) PCT Filed: Oct. 2, 2018
(86) PCT No.: PCT/JP2018/036847

§ 371 Date: Mar. 30, 2021

(51) Int. Cl. G01S 13/90; G06T 7/194; G06T 7/143; G01S 13/91

(52) U.S. Cl. CPC G01S 13/9027; G06T 7/194; G06T 2207/10028; G01S 13/917; G06T 7/143

(57) ABSTRACT

The ship candidate pixel derivation means 81 regards each individual pixel of an input synthetic aperture radar image as a pixel of interest, and determines, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell. The integration means 82 integrates a plurality of determination results of whether the pixel of interest is the ship candidate pixel or not, for each pixel of interest. The ship pixel detection means 83 detects the pixel corresponding to the ship, based on integration results obtained for each pixel of interest by the integration means 82.

### TECHNICAL FIELD

The present invention relates to a ship detection system, a ship detection method and a ship detection program for detecting ships from synthetic aperture radar images.

### BACKGROUND ART

In recent years, environmental destruction and resource depletion due to illegal fishing has become a global problem.

In order to deter illegal fishing, the Automatic Identification System (AIS) and Synthetic Aperture Radar (SAR) have been attracting attention. AIS communicates information such as ship identification code, type, position, course, speed, and voyage status with ships and ground base station. By applying a ship detection process to SAR images and identifying ships that cannot be matched with AIS as illegal fishing ships, it is possible to understand the actual situation of illegal fishing in the area of interest and to optimize patrol routes by patrol ships.

Non-patent literature 1 discloses ship detection using adaptive thresholding. The concept of the adaptive thresholding is very simple. The adaptive thresholding is a method to detect pixels that are extremely bright compared to the surrounding pixels as a ship. This method is achieved by setting an appropriate threshold for pixels to be detected as a ship based on statistical analysis of the surrounding pixels. The way of a Constant False Alarm Rate (CFAR) is used for setting an appropriate threshold. In CFAR, surrounding pixels other than a detected object are regarded as background pixels, and a distribution of pixel values of background pixels is fitted to a predetermined probability density function. A random variable indicating that a cumulative distribution function of obtained predetermined probability density becomes to be a false alarm rate is used as the threshold. K-distribution, generalized gamma distribution, etc. are used as the probability density function.

Non-patent literature 2 discloses methods called Two Parameter CFAR (TP-CFAR) and Cell-Averaging CFAR (CA-CFAR) as CFAR-based methods. These two methods assume that a distribution of pixel values is Gaussian, and calculate a threshold based on the results of calculation of a local mean pixel value and a local pixel value variance. Since the local mean pixel value and the local pixel value variance can be calculated at a computational cost of

O(1) [Math. 1]

per pixel, it becomes to be possible to perform processing at a high speed by using the TP-CFAR or the CA-CFAR.

Patent literature 1 also describes an image processing system that extracts ship candidate areas from input image data. The image processing system described in patent literature 1 decides a pixel detected as a ship candidate in input image data as a representative point, and determines a frame of a predetermined range surrounding the representative point. The image processing system then extracts a first region being a group of pixels each having a pixel value equal or greater than a predetermined threshold among pixels existing inside the frame, and a second region being a group of pixels each having a pixel value equal or greater than a predetermined threshold among pixels existing outside the frame, which are adjacent to the frame at least at one point and each pixel is adjacent to each other. The image processing system then combines the first region and the second region to extract the ship candidate region.

### CITATION LIST

### Patent Literature

Patent Literature 1: Japanese Patent Laid-Open No. 2004-302572

### Non-Patent Literature

Non-Patent Literature 1: J. Martin-de-Nicolas, P. Jarabo-Amores, N. Rey-Maestre, D. Mata-Moya, J. L. Barcena-Humanes, “ANON-PARAMETRIC CFAR DETECTION BASED ON SAR SEA CLUTTER STATISTICAL MODELING,” ICIP 2015, P. 4426-4430

Non-Patent Patent Literature 2: D. J. Crisp, “The State-of-the-Art in Ship Detection in Synthetic Aperture Radar Imagery,” Intell., Surveillance and Reconnaissance Div., Inf. Sci. Lab., Def., Sci. Technol. Org., Edinburgh, S. A., Australia, May 2004, Res. Rep. DSTO-RR-0272.

### SUMMARY OF INVENTION

### Technical Problem

The size of the ships to be detected ranges from 10 meters for small ones to several hundred meters for large ones.

Since the ship detection method disclosed in non-patent literature 1 compares every single pixel, it is possible to detect ships regardless of their size. On the other hand, however, there is a problem that a single ship is divided into multiple parts for detection. In addition, since high waves tend to reflect radar waves, pixels that correspond to high waves tend to be bright pixels. Therefore, the method disclosed in non-patent literature 1 has a problem that high waves are easily mis-detected as ships.

In addition, the ship detection method disclosed in non-patent literature 2 is more robust than the method described in the non-patent literature 1 for the problem of a single ship being divided into multiple parts, because it performs integrated analysis using multiple pixels around the pixel of interest when calculating the local mean and variance. On the other hand, there is a problem that it requires complicated parameter settings such as cell size settings for calculating the local mean and variance, and the size of the ship that can be detected is limited by the cell size.

Therefore, it is an object of the present invention to provide a ship detection system, a ship detection method, and a ship detection program that can stably detect ships of various sizes.

### Solution to Problem

A ship detection system comprising according to the present invention includes ship candidate pixel derivation means which regards each individual pixel of an input synthetic aperture radar image as a pixel of interest, and determines, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell, integration means which integrates a plurality of determination results of whether the pixel of interest is the ship candidate pixel or not, for each pixel of interest, and ship pixel detection means which detects the pixel corresponding to the ship, based on integration results obtained for each pixel of interest by the integration means.

A ship detection method according to the present invention, implemented by a computer, includes executing a ship candidate pixel derivation process of regarding each individual pixel of an input synthetic aperture radar image as a pixel of interest, and determining, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell, executing an integration process of integrating a plurality of determination results of whether the pixel of interest is the ship candidate pixel or not, for each pixel of interest, and executing a ship pixel detection process of detecting the pixel corresponding to the ship, based on integration results obtained for each pixel of interest in the integration process.

A ship detection program according to the present invention, causing a computer to execute a ship candidate pixel derivation process of regarding each individual pixel of an input synthetic aperture radar image as a pixel of interest, and determining, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell, an integration process of integrating a plurality of determination results of whether the pixel of interest is the ship candidate pixel or not, for each pixel of interest, and a ship pixel detection process of detecting the pixel corresponding to the ship, based on integration results obtained for each pixel of interest in the integration process.

### Advantageous Effects of Invention

According to the present invention, ships of various sizes can be detected in a stable manner.

### BRIEF DESCRIPTION OF DRAWINGS

FIG. 1 It depicts a block diagram of an example of a ship detection system of the first example embodiment according to the present invention.

FIG. 2 It depicts a block diagram of an example of an image processing unit.

FIG. 3 It depicts an explanatory diagram showing types of cells used in ship detection.

FIG. 4 It depicts a flowchart showing an example of processing process of an image processing unit in the first example embodiment.

FIG. 5 It depicts a block diagram of an example of an image processing unit in the second example embodiment.

FIG. 6 It depicts a schematic diagram showing an example of fitting a pixel value distribution of the sea surface with a generalized gamma distribution.

FIG. 7 It depicts a flowchart showing an example of processing of an image processing unit in the second example embodiment.

FIG. 8 It depicts a flowchart showing an example of processing of an image processing unit in the second example embodiment.

FIG. 9 It depicts a schematic block diagram of a computer configuration for a ship detection system in each example embodiment.

FIG. 10 It depicts a block diagram of a summarized example of a ship detection system according to the present invention.

### DESCRIPTION OF EMBODIMENTS

Hereinafter, example embodiments of the present invention will be described with reference to the drawings. It should be noted that a synthetic aperture radar image is an image obtained by a synthetic aperture radar, and the synthetic aperture radar image is hereinafter referred to as the SAR image.

### Example Embodiment 1

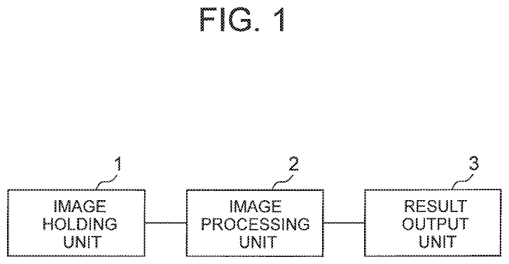

FIG. 1 is a block diagram of an example of a ship detection system of the first example embodiment according to the present invention. The ship detection system of the first example embodiment comprises an image holding unit 1, an image processing unit 2, and a result output unit 3.

The image holding unit 1 is, for example, a storage device that holds a database of SAR images obtained by irradiating electromagnetic waves onto the sea surface from an antenna of the synthetic aperture radar. The information processing device including such a storage device and the image processing unit 2 may be connected through a communication network. The SAR image is input to the image processing unit 2 from the image holding unit 1.

The image processing unit 2 executes the process of detecting pixels corresponding to a ship in pixels of the SAR image input from the image holding unit 1, and outputs the information indicating the pixels in the SAR image to the result output unit 3.

The result output unit 3 is, for example, an output device that outputs a SAR image in which pixels corresponding to a ship are represented as the ship. The output device may be a display device or a printer. The output device may also be a storage medium (e.g., a hard disk or a memory card) that stores the processing results of the image processing unit 2 and can be read out from outside. The information processing device including such various types of output devices and the image processing unit 2 may be connected through a communication network.

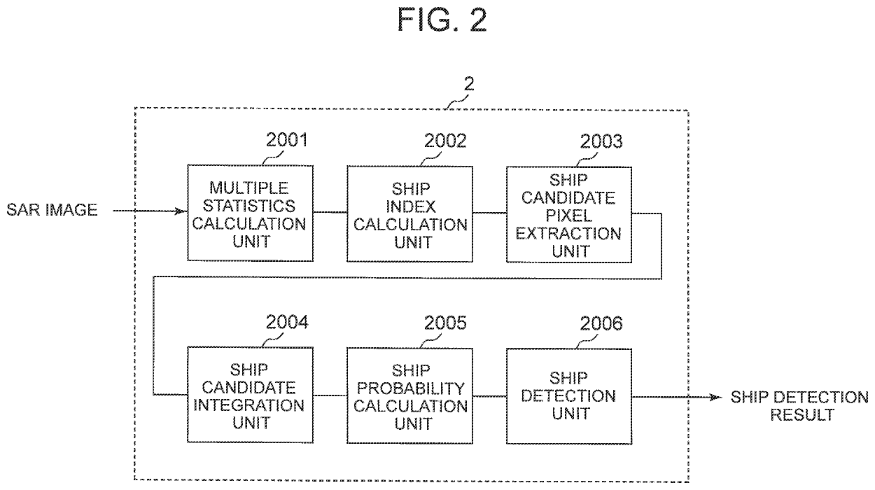

FIG. 2 is a block diagram of an example of the image processing unit 2. The image processing unit 2 includes a multiple statistics calculation unit 2001, a ship index calculation unit 2002, a ship candidate pixel extraction unit 2003, a ship candidate integration unit 2004, a ship probability calculation unit 2005, and a ship detection unit 2006.

The multiple statistics calculation unit 2001 regards each individual pixel of the SAR image input from the image holding unit 1 as the pixel of interest, and calculates multiple local pixel value statistics for each pixel of interest. Specifically, the multiple statistics calculation unit 2001 changes the cell size of the cell including the pixel of interest for each pixel of interest, and calculates a pixel value statistic for each cell size. As a result, multiple pixel value statistics are obtained for each individual pixel of interest. The multiple statistics calculation unit 2001 outputs the multiple pixel value statistics calculated for each pixel of interest to the ship index calculation unit 2002.

The cell size can also be referred to as the window size.

The ship index calculation unit 2002 calculates a ship index value for each pixel of interest, which indicates the certainty that the pixel of interest corresponds to a ship, using the plurality of pixel value statistics calculated for the pixel of interest. At this time, the ship index calculation unit 2002 calculates a plurality of ship index values for each individual pixel of interest. The ship index calculation unit 2002 outputs the plural ship index values calculated for each pixel of interest to the ship candidate pixel extraction unit 2003.

The ship candidate pixel extraction unit 2003 determines whether the pixel of interest is a ship candidate pixel, which is a candidate of a pixel representing a ship, by comparing a plurality of ship index values calculated for each pixel of interest with a predetermined threshold value. If the ship index value is greater than the predetermined threshold, the ship candidate pixel extraction unit 2003 determines that the pixel of interest is the ship candidate pixel. Since a plurality of ship index values is calculated for one pixel of interest, the pixel of interest may be determined to be a ship candidate pixel or not, depending on the ship index value. In other words, multiple determination results can be obtained for one pixel of interest. The ship candidate pixel extraction unit 2003 outputs the multiple determination results obtained for each pixel of interest to ship candidate integration unit 2004.

The ship candidate integration unit 2004 integrates the obtained multiple determination results regarding the pixel of interest for each pixel of interest. Specifically, the ship candidate integration unit 2004 counts the number of times the pixel of interest is determined to be a ship candidate pixel, for each pixel of interest. The counting result is hereinafter referred to as the number of ship candidate determinations. The number of ship candidate determinations is obtained for each pixel of interest. The ship candidate integration unit 2004 outputs the number of ship candidate determinations obtained for each pixel of interest to the ship probability calculation unit 2005.

The ship probability calculation unit 2005 calculates a probability (hereinafter referred to as “ship probability”) that the pixel of interest is a ship-derived pixel based on the number of ship candidate determinations for each pixel of interest. The ship probability calculation unit 2005 outputs the ship probability calculated for each pixel of interest to the ship detection unit 2006.

The ship detection unit 2006 compares the ship probability with a predetermined threshold for each pixel of interest, and detects the pixel of interest whose ship probability is equal to or greater than the predetermined threshold as a pixel corresponding to a ship (hereinafter referred to as a “ship pixel”). The ship detection unit 2006 outputs the information indicating the ship pixel in the SAR image to the result output unit 3.

Hereinafter, more detail description is provided regarding the multiple statistics calculation unit 2001, the ship index calculation unit 2002, the ship candidate pixel extraction unit 2003, the ship candidate integration unit 2004, the ship probability calculation unit 2005, and the ship detection unit 2006.

First, the multiple statistics calculation unit 2001 will be explained. The input SAR image is assumed to be S. In the SAR image S, when the position of the pixel of interest is (x,y), the pixel value of the pixel of interest is denoted as S(x,y).

As described above, the multiple statistics calculation unit 2001 changes the cell size of the cell including the pixel of interest, for each pixel of interest, and calculates the pixel value statistic for each cell size. Here, when calculating the pixel value statistic for a single cell size, the multiple statistics calculation unit 2001 calculates the pixel value statistics by applying box filter process for obtaining the local pixel value average to the cell size. The box filter process is shown below. Here, it is assumed that the cell is a square, and the box filter process for a square cell is shown. The cell size is represented by the length of one side (the number of pixels corresponding to one side) of the cell, and the cell size is defined as wᵢ. Furthermore, wᵢ′=(wᵢ−1)/2 is defined. In this case, the box filter process to obtain the local pixel value average at the position (x,y) of the pixel of interest is represented by the equation (1) shown below.

[Math. 2]

Uᵢ(x, y)=Σ_{n=y-w′}_{ᵢ}^{y+w′}^{ᵢ}Σ_{m=x-w′}_{ᵢ}^{x+w′}^{ᵢ}S(m, n) (1)

The multiple statistics calculation unit 2001 calculates the pixel value statistic Uᵢ(x,y) for each cell size for the pixel of interest at position (x,y) by calculating equation (1). The multiple statistics calculation unit 2001 performs the same process for each of the other pixels of interest.

At this point, the multiple statistics calculation unit 2001 does not perform the normalization process in consideration of the processing in the later stage. In this example embodiment, the case where the cell is a square is used as an example, but the cell does not have to be a square.

The cell size may be specified by the user.

Alternatively, the multiple statistics calculation unit 2001 may calculate the multiple cell sizes using the information regarding the size of the ship to be detected. An example of the calculation of the cell size is shown below. The number of cells (the number of cell sizes) is assumed to be N. The maximum length of the ship to be detected is Lₘₐₓ, and the minimum length of the ship to be detected is Lₘᵢₙ. Let R be the surface resolution of the input SAR image. The values of N, Lₘₐₓ, Lₘᵢₙ, and R are assumed to be given in advance. In this case, the multiple statistics calculation unit 2001 calculates the multiple cell sizes by calculating equation (2), equation (3) and equation (4) shown below.

$$\begin{matrix}[ Math . 3 ] & \\ {W}_{min} = {L}_{min} / R & ( 2 ) \\ {W}_{max} = {L}_{max} / R & ( 3 ) \\ {w}_{i} = {L}_{min} + \frac{i}{N - 1} ( {L}_{max} - {L}_{min} ) , i = 0 , 1 , 2 , … , N - 1 & ( 4 )\end{matrix}$$

Since it is desirable for wᵢ to be an odd number, the multiple statistic calculation unit 2001 rounds wᵢ obtained in equation (4) to the nearest odd value. The cell size calculated by the multiple statistics calculating unit 2001 may be combined with the cell size specified by the user. In addition, a larger cell size or sizes may be added to the N cell sizes calculated by the multiple statistics calculation unit 2001.

The multiple statistics calculation unit 2001 may calculate a pixel value feature quantity according to the cell size by applying the box filter process for obtaining the local variance of pixel values to the cell size. The box filter process for obtaining the local variance of pixel values is represented by equation (5) shown below. In other words, the multiple statistics calculation unit 2001 may calculate the pixel value feature quantity according to the cell size by calculating equation (5) shown below.

[Math. 4]

Vᵢ(x, y)=Σ_{n=y-w′}_{ᵢ}^{y+w′}^{ᵢ}Σ_{m=x-w′}_{ᵢ}^{x+w′}^{ᵢ}S(m, n)×S(m, n) (5)

The multiple statistics calculation unit 2001 may calculate the pixel value statistic Vᵢ(x,y) for each cell size for the pixel of interest at position (x,y) by calculating equation (5). In this case, the multiple statistics calculation unit 2001 performs the same process for each of the other pixels of interest.

At this point, in consideration of the later processing, the multiple statistics calculation unit 2001 does not perform the normalization process of dividing by the number of pixels in the cell and subtracting the square of the average value.

Also, as already explained, w′ᵢ=(wᵢ−1)/2.

Next, the ship index calculation unit 2002 will be explained. As described above, the ship index calculation unit 2002 calculates a plurality of ship index values for each individual pixel of interest.

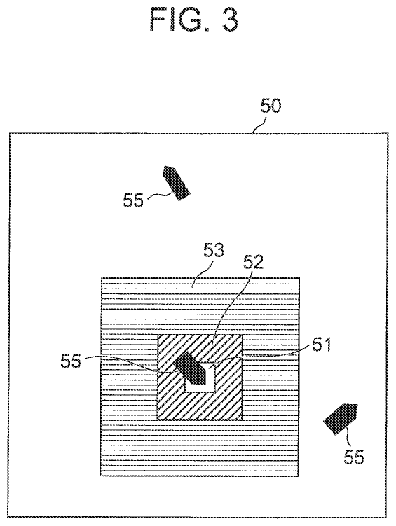

FIG. 3 is an explanatory diagram showing types of cells used in ship detection. FIG. 3 shows a target cell 51, a guard cell 52 and a background cell 53 in a SAR image 50 of a ship 55. The target cell 51 is the cell including the pixel of interest (not shown in FIG. 3). The background cell 53 is a cell including pixels around the target cell. The guard cell 52 is a cell that corresponds to an area between the background cell 53 and the target cell 51. The guard cell 52 is set to take into account the fact that the detected object protrudes from the target cell 51 and to prevent the analysis of the surrounding pixels from being degraded by the detected object.

Here, it is assumed assume that the outer edges of the target cell 51, guard cell 52, and background cell 53 are squares. The cell size of each of the target cell 51, guard cell 52, and background cell 53 is represented by the length of one side (the number of pixels corresponding to one side) of the square as the outer edge. Hereinafter, the cell size of the target cell 51 is denoted as wₜₐᵣ, the cell size of the guard cell 52 is denoted as w_{grd}, and the cell size of the background cell 53 is denoted as w_{bgr}.

The ship index calculation unit 2002 calculates the pixel value statistic of the target cell 51 and the pixel value statistic of the background cell 53 using the pixel value statistics calculated for the plurality of cell sizes with respect to the pixel of interest. In this example embodiment, the ship index calculation unit 2002 calculates the mean pixel value as the pixel value statistic of the target cell 51 and the background cell 53. In addition to the mean pixel value, the ship index calculation unit 2002 may also calculate the variance value of the pixel value as the pixel value statistic of the background cell 53.

Let Uₜₐᵣ be the result of the box filter process (the calculation result of equation (1)) for obtaining the pixel value average, corresponding to the cell size of the target cell 51. Similarly, the calculation result of equation (1) corresponding to the cell size of the guard cell 52 is assumed to be U_{grd}. Similarly, the calculation result of equation (1) corresponding to the cell size of the background cell 53 is assumed to be U_{bgr}.

The result of the box filter process (the calculation result of equation (5)) for obtaining the local variance of pixel values, corresponding to the cell size of the guard cell 52, is assumed to be V_{grd}. Similarly, the calculation result of equation (5) corresponding to the cell size of the background cell 53 is assumed to be V_{bgr}.

The ship index calculation unit 2002 calculates the pixel value statistic of the target cell 51 (specifically, the mean pixel value of the target cell 51, μₜₐᵣ) using equation (6) shown below.

[Math. 5]

μₜₐᵣ=Uₜₐᵣ/(wₜₐᵣ×wₜₐᵣ) (6)

The ship index calculation unit 2002 calculates the pixel value statistic of the background cell 53 (specifically, the mean pixel value of the background cell 53, μ_{bgr}) using equation (7) shown below.

[Math. 6]

μ_{bgr}=(U_{bgr}−U_{grd})/(w_{bgr}×w_{bgr}−w_{grd}×w_{grd}) (7)

When the variance value of pixel values is also calculated as the pixel value statistic of the background cell 53, he ship index calculation unit 2002 calculates the variance value σ_{bgr}² of pixel values of the background cell 53 by the equation (8) shown below.

[Math. 7]

σ_{bgr}²=(V_{bgr}−V_{grf})/(w_{bgr}×w_{bgr}−w_{grd}×w_{grd})−μ_{brg}² (8)

The ship index calculation unit 2002 calculates a ship index value using the mean pixel value μₜₐᵣ of the target cell 51 and the mean pixel value μ_{bgr} of the background cell 53 calculated as described above (and may also use the variance value σ_{bgr}² of the pixel value of the background cell 53).

When CA-CFAR (Cell-Averaging CFAR) is used as the ship index value, the ship index calculation unit 2002 calculates the ship index value ICA-CFAR by calculating I_{CA-CFAR}=μₜₐᵣ−μ_{bgr})/σ_{bgr}.

In the case where TP-CFAR (Two Parameter CFAR) is used as the ship index value, the ship index calculation unit 2002 calculates the ship index value ITP-CFAR by calculating I_{TP-CFAR}=(μₜₐᵣ−μ_{bgr})σ_{bgr}.

The ship index calculation unit 2002 repeats the above process while changing the cell size of the target cell 51 and the cell size of the guard cell 52 for one cell of interest, and calculates M ship index values I_{CA-CFAR(h)}, h=1, 2, . . . , M, or I_{TP-CFAR(h)}, h=1, 2, . . . , M. At this time, the cell size of the background cell 53 may be set to a certain value or may be changed in the same way as the cell sizes of the target cell 51 and the guard cell 52. “h” is an index number of the combination of the cell sizes of the target cell 51 and the cell size of the guard cell 52. Here, the number of combinations of the cell size of the target cell 51 and the cell size of the guard cell 52 is set to M.

The ship index calculation unit 2002 performs the process of calculating the M ship index values for each individual pixel of interest.

The ship index calculation unit 2002 may calculate both I_{CA-CFAR(h)}, h=1, 2, . . . , M, and I_{TP-CFAR(h)}, h=1, 2, . . . , M, in the above process.

Next, the ship candidate pixel extraction unit 2003 will be explained. As described above, the ship candidate pixel extraction unit 2003 determines for each pixel of interest whether the pixel of interest is a ship candidate pixel or not. For each pixel of interest, the ship candidate pixel extraction unit 2003 obtains a plurality of determination results.

First, the case is explained where the ship index calculation unit 2002 calculates I_{CA-CFAR(h)}, h=1, 2, . . . , M, for each pixel of interest. When the position of the pixel of interest is (x,y), the ship index value of that pixel of interest is denoted as I_{CA-CFAR(h)}(x,y). The pixel corresponding to the position (x,y), which is represented by a binary pixel value depending on whether the pixel of interest is a ship candidate pixel or not, is denoted as O_{CA-CFAR(h)}(x,y). When the ship index value I_{CA-CFAR}(h) is greater than the predetermined threshold, the ship candidate pixel extraction unit 2003 determines that the pixel of interest is a ship candidate pixel, and when the ship index value I_{CA-CFAR}(h) is less than or equal to the predetermined threshold, it determines that the pixel of interest is not a ship candidate pixel. The predetermined threshold value is set to τ_{CA-CFAR}. Specifically, the ship candidate pixel extraction unit 2003 determines the value of O_{CA-CFAR(h)}(x,y) for each case from h=1 to h=M, according to equation (9) shown below.

$$\begin{matrix}[ Math . 8 ] & \\ {O}_{CA - CFAR ( h )} ( x , y ) = \{ \begin{matrix}1 & {I}_{C A - C F A R ( h )} ( x , y ) > {τ}_{CA - CFAR} \\ 0 & otherwise\end{matrix} & ( 9 )\end{matrix}$$

The ship candidate pixel extraction unit 2003 performs this process for each individual pixel of interest. O_{CA-CFAR}(h)(x,y)=1 means a determination result such that the pixel of interest is a ship candidate pixel. O_{CA-CFAF(h)}(x,y)=0 means a determination result such that the pixel of interest is not a ship candidate pixel. M O_{CA-CFAR(h)}(x,y) are obtained for one pixel of interest.

A set of O_{CA-CFAR(h)}(x,y) for each position where h is a common value is a binary image with ship candidate pixels represented by 1 and non-ship candidate pixels represented by 0.

Next, the case is explained where the ship index calculation unit 2002 calculates I_{TP-CFAR}(h), h=1, 2, . . . , M, for each pixel of interest. When the position of the pixel of interest is (x,y), the ship index value of the pixel of interest is denoted as I_{TP-CFAR(h)}(x,y). The pixel corresponding to the position (x,y), which is represented by a binary pixel value depending on whether the pixel of interest is a ship candidate pixel or not, is denoted as O_{TP-CFAR(h)}(x,y). When the ship index value I_{TP-CFAR(h)} is greater than the predetermined threshold, the ship candidate pixel extraction unit 2003 determines that the pixel of interest is a ship candidate pixel, and when the ship index value I_{TP-CFAR}(h) is less than or equal to the predetermined threshold, it determines that the pixel of interest is not a ship candidate pixel. The predetermined threshold value is set to τ_{TP-CFAR} Specifically, the ship candidate pixel extraction unit 2003 determines the value of O_{TP-CFAR(h)}(x,y) for each of the cases from h=1 to h=M according to equation (10) shown below.

$$\begin{matrix}[ Math . 9 ] & \\ {O}_{TP - CFAR ( h )} ( x , y ) = \{ \begin{matrix}1 & {I}_{TP - CFA R ( h )} ( x , y ) > {τ}_{TP - CFAR} \\ 0 & otherwise\end{matrix} & ( 10 )\end{matrix}$$

The ship candidate pixel extraction unit 2003 performs this process for each individual pixel of interest. O_{TP-CFAR(h)}(x,y)=1 means a determination result such that the pixel of interest is a ship candidate pixel. O_{TP-CFAR(h)}(x,y)=0 means a determination result such that the pixel of interest is not a ship candidate pixel. M O_{TP-CFAR(h)}(x,y) are obtained for one pixel of interest.

A set of O_{TP-CFAR(h)}(x,y) for each position where h is a common value is a binary image with ship candidate pixels represented by 1 and non-ship candidate pixels represented by 0.

In the above process, the ship candidate pixel extraction unit 2003 may set the threshold values τ_{CA-CFAR} and τ_{TP-CFAR} as fixed values or vary them for each h.

Next, the ship candidate integration unit 2004 will be explained. As described above, the ship candidate integration unit 2004 integrates the plurality of determination results obtained for each pixel of interest with respect to the pixel of interest. Specifically, the ship candidate integration unit 2004 counts a number of times that the pixel of interest is determined to be a ship candidate pixel for each pixel of interest. This counting result is referred to as the number of ship candidate determinations.

First, the case is explained where the ship candidate pixel extraction unit 2003 determines the value of O_{CA-CFAR(h)}(x,y) for each case from h=1 to h=M. In this case, the ship candidate integration unit 2004 determines the number of ship candidate determinations C by calculating equation (11) as shown below.

[Math. 10]

C=ΣO_{CA-CFAR(h)} (11)

The ship candidate integration unit 2004 performs the process of obtaining the number of ship candidate determinations C for each pixel of interest according to equation (11).

The same applies to the case where the ship candidate pixel extraction unit 2003 determines the value of O_{TP-CFAR(h)}(x,y) for each case from h=1 to h=M. In other words, the ship candidate integration unit 2004 determines the number of ship candidate determinations C by calculating equation (12) as shown below.

[Math. 11]

C=ΣO_{TP-CFAR(h)} (12)

The ship candidate integration unit 2004 performs the process of obtaining the number of ship candidate determinations C for each pixel of interest according to equation (12).

When the ship candidate pixel extraction unit 2003 determines both the value of O_{CA-CFAR(h)}(x,y) and the value of O_{TP-CFAR(h)}(x,y) for each case from h=1 to h=M, the ship candidate integration unit 2004 calculates the number of ship candidate determinations C using the following equation (13) below.

### [Math. 12]

C=ΣO_{CP-CFAR(h)}+ΣO_{TP-CFAR(h)} (13)

In this case, too, the ship candidate integration unit 2004 performs the process of obtaining the number of ship candidate determinations C by equation (13) for each pixel of interest.

Next, the ship probability calculation unit 2005 will be explained. As described above, the ship probability calculation unit 2005 calculates a probability that the pixel of interest is a ship-derived pixel (ship probability) based on the number of ship candidate determinations for each pixel of interest.

The ship probability calculation unit 2005 calculates the ship probability by normalizing the number of ship candidate determinations C obtained by the ship candidate integration unit 2004 using M (the number of combinations of the cell size of the target cell 51 and the cell size of the guard cell 52).

For example, suppose that the ship candidate integration unit 2004 calculates the number of ship candidate determinations C using equation (11) or equation (12). In this case, the ship probability calculation unit 2005 obtains the ship probability P by calculating P=C/M. The ship probability calculation unit 2005 executes the process of calculating the ship probability P for each pixel of interest.

Further, for example, suppose that the ship candidate integration unit 2004 calculates the number of ship candidate determinations C using equation (13). In this case, the ship probability calculation unit 2005 obtains the ship probability P by calculating P=C/(2M). In this case, too, the ship probability calculation unit 2005 executes the process of calculating the ship probability P for each pixel of interest.

It should be noted that the problem of a single ship being detected in multiple parts can be improved by using CA-CFAR or TP-CFAR based methods. This problem can be further improved by using kernel density estimation to integrate local ship probabilities for and analyze the probability. When performing kernel density estimation, the ship probability calculation unit 2005 applies the convolution operation P′=G*P to the ship probability P, using a predetermined Gaussian kernel G, and outputs P′ obtained by this operation to the ship detection unit 2006.

Next, the ship detection unit 2006 will be explained. As described above, the ship detection unit 2006 compares the ship probability with a predetermined threshold for each pixel of interest, and detects a pixel of interest whose ship probability is greater than or equal to the predetermined threshold as the pixel corresponding to a ship (ship pixel).

The pixel corresponding to the position (x,y), which is represented by a binary pixel value depending on whether the pixel of interest is a ship pixel or not, is denoted as Oₛₕᵢₚ(x,y). When the ship probability P is greater than or equal to a predetermined threshold, the ship detection unit 2006 determines that the pixel of interest is a ship pixel, and when the ship probability P is less than the predetermined threshold, it determines that the pixel of interest is not a ship pixel. This predetermined threshold is called τₛₕᵢₚ. The ship detection unit 2006 obtains the value of Oₛₕᵢₚ(x,y) according to the following equation (14).

$$\begin{matrix}[ Math . 13 ] & \\ {O}_{s h i p} ( x , y ) = \{ \begin{matrix}1 & P ( x , y ) \geq {τ}_{s h i p} \\ 0 & otherwise\end{matrix} & ( 14 )\end{matrix}$$

The ship detection unit 2006 performs this process for each individual pixel of interest. Oₛₕᵢₚ(x,y)=1 means that the pixel of interest is a ship pixel. Oₛₕᵢₚ(x,y)=0 means a determination result such that the pixel of interest is not a ship pixel. Therefore, the ship detection unit 2006 may detect the pixel of interest at the position where Oₛₕᵢₚ(x,y)=1 as a ship pixel.

The above threshold value τₛₕᵢₚ may be set to τₛₕᵢₚ=0.5 if it follows a simple majority rule. The user may also fine-tune τₛₕᵢₚ. If the ship probability was obtained by applying the above kernel density estimation, then it may be corrected to τₛₕᵢₚ=0.5*G_{c} using the central coefficient G_{c} of the Gaussian kernel G.

Further, as a post-processing of the detection of ship pixels, the ship detection unit 2006 may also perform a process to uniquely label each clump (cluster) of ship pixels, based on the connectivity of the ship pixels. Furthermore, the ship detection unit 2006 may exclude clusters that do not fall within a predetermined size range from the results of ship detection. In addition, since SAR images are often accompanied by geographic information, the ship detection unit 2006 may refer to the land area data in the area mapped in the SAR image, and if the location of the pixel detected as a ship pixel corresponds to a land area, the ship pixel may be excluded from the detection result. In this case, the land area data in the area mapped in the SAR image may be separately input to the ship detection unit 2006.

The image processing unit 2, which includes the multiple statistics calculation unit 2001, the ship index calculation unit 2002, the ship candidate pixel extraction unit 2003, the ship candidate integration unit 2004, the ship probability calculation unit 2005, and the ship detection unit 2006, is realized, for example, by a CPU (Central Processing Unit) of a computer that operates according to a ship detection program. In this case, for example, the CPU may read the ship detection program from a program recording medium such as a program storage device of the computer, and operate as the image processing unit 2 including the multiple statistics calculation unit 2001, the ship index calculation unit 2002, the ship candidate pixel extraction unit 2003, the ship candidate integration unit 2004, the ship probability calculation unit 2005, and the ship detection unit 2006, according to the ship detection program.

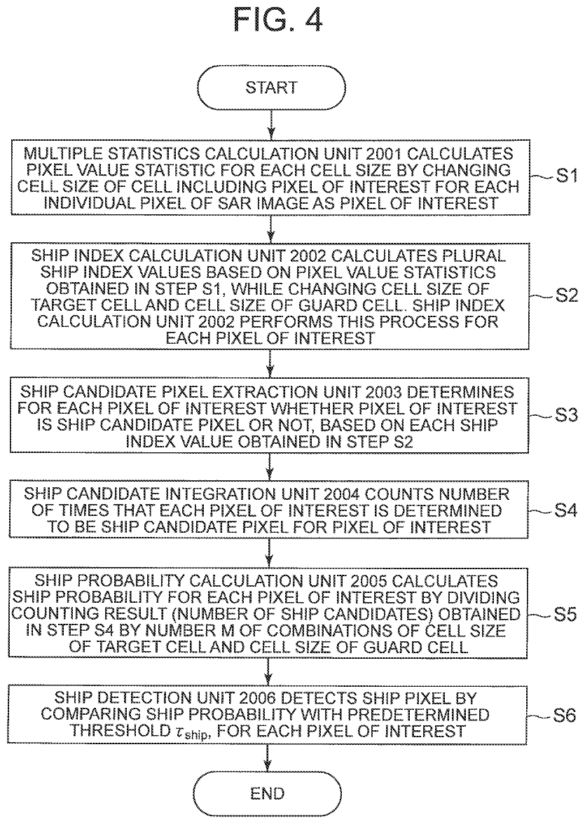

Next, the processing process is explained. FIG. 4 is a flowchart showing an example of the processing process of the image processing unit 2 of the first example embodiment. The matters already explained are omitted as appropriate.

First, the multiple statistics calculation unit 2001 calculates the pixel value statistic for each cell size by changing the cell size of the cell including the pixel of interest for each individual pixel of the input SAR image as the pixel of interest (step S1). As a result, multiple pixel value statistics are obtained for each individual pixel of interest.

Next, the ship index calculation unit 2002 calculates a plurality of ship index values based on the pixel value statistics obtained in step S1, while changing the cell size of the target cell and the cell size of the guard cell. The ship index calculation unit 2002 performs this process for each pixel of interest (step S2).

Next, the ship candidate pixel extraction unit 2003 determines for each pixel of interest whether the pixel of interest is the ship candidate pixel or not, based on each ship index value obtained in step S2 (step S3). As a result, multiple determination results are obtained for each pixel of interest.

Next, the ship candidate integration unit 2004 counts a number of times that each pixel of interest is determined to be a ship candidate pixel for the pixel of interest (step S4).

Next, the ship probability calculation unit 2005 calculates the ship probability for each pixel of interest by dividing the counting result (number of ship candidates) obtained in step S4 by the number M of combinations of the cell size of the target cell and the cell size of the guard cell (step S5).

Next, the ship detection unit 2006 detects a ship pixel by comparing the ship probability with a predetermined threshold τₛₕᵢₚ, for each pixel of interest (step S6). The ship detection unit 2006 outputs information indicating the ship pixel in the SAR image (for example, information indicating a position of the ship pixel in the SAR image) to the result output unit 3.

When the process of the ship detection unit 2006 is completed, the process of the image processing unit 2 is finished.

The result output unit 3, for example, outputs a SAR image in which pixels corresponding to a ship are highlighted as the ship. However, the output format by the result output unit 3 is not limited to this example.

According to this example embodiment, the image processing unit 2 determines whether the pixel of interest is a ship candidate pixel or not, for each combination of the cell size of the target cell and the cell size of the guard cell. Then, the image processing unit 2 integrates the determination results as to whether the pixel of interest is a ship candidate pixel or not, for each pixel of interest. Then, the image processing unit 2 detects the ship pixel based on the integration result (number of ship candidates) obtained for each pixel of interest. Therefore, detection omissions and false detections that may occur in a cell size can be covered by other cell sizes. Therefore, according to this example embodiment, ships of various sizes can be stably detected from a SAR image.

### Example Embodiment 2

In the first example embodiment, in the process of calculating the ship index value I_{CA-CFAR} and the ship index value I_{TP-CFAR}, it is preferable to make the cell size of the background cell 53 as large as possible in order to obtain stable pixel value statistic of the background cell. Ideally, the background cell should include only pixels that correspond to the sea surface. However, if the cell size of the background cell is randomly increased, the possibility, that the background cell includes pixels that correspond to a ship different from the ship to be detected based on the pixel of interest, increases. If such pixels are included in the background cell, it becomes difficult to stably calculate the pixel value statistic of the background cell, therefore, the ship detection performance deteriorates.

The second example embodiment of the ship detection system enables more stable detection of ships than the first example embodiment of the ship detection system. The second example embodiment of the ship detection system is described below.

The target cell 51, the guard cell 52 and the background cell 53 (refer to FIG. 3) are the same as the target cell 51, the guard cell 52 and the background cell 53 in the first example embodiment.

The second example embodiment of the ship detection system of the present invention can be represented as shown in FIG. 1, similar to the first example embodiment. The image holding unit 1 and the result output unit 3 (refer to FIG. 1) in the second example embodiment are the same as the image holding unit 1 and the result output unit 3 in the first example embodiment.

The image processing unit 2 in the second example embodiment executes the process of detecting the pixel corresponding to a ship from each pixel of the SAR image input from the image holding unit 1, and outputs information indicating that pixel in the SAR image to the result output unit 3. This point is the same as in the first example embodiment. However, the elements included in the image processing unit 2 and their operations are partially different from the first example embodiment. The image processing unit 2 of the second example embodiment is described below.

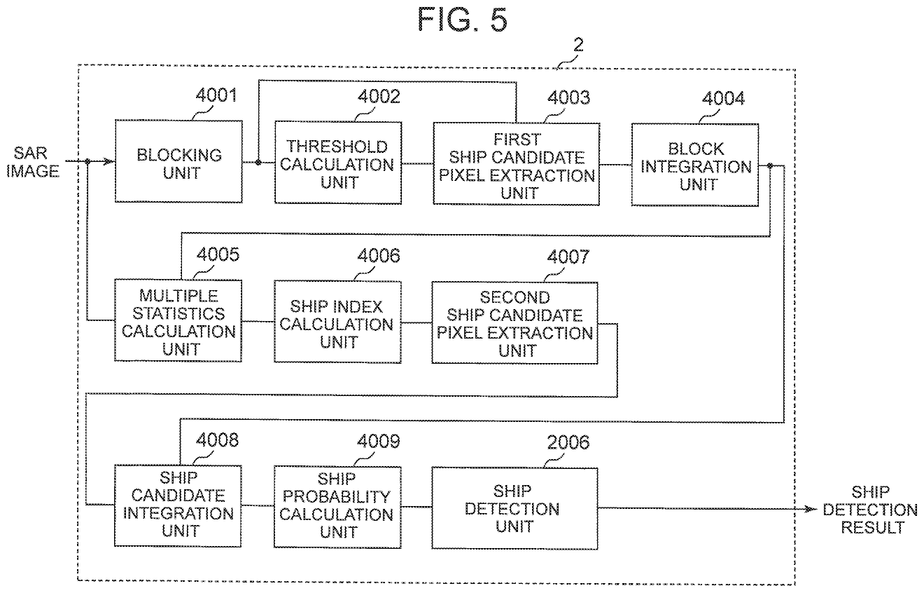

FIG. 5 is a block diagram showing an example of the image processing unit 2 in the second example embodiment. The image processing unit 2 of the second example embodiment includes a blocking unit 4001, a threshold calculation unit 4002, a first ship candidate pixel extraction unit 4003, a block integration unit 4004, a multiple statistics calculation unit 4005, a ship index calculation unit 4006, a second ship candidate pixel extraction unit 4007, a ship candidate integration unit 4008, a ship probability calculation unit 4009, and ship detection unit 2006.

The ship detection unit 2006 is the same as the ship detection unit 2006 in the first example embodiment (refer to FIG. 2), and a detailed explanation is omitted.

The blocking unit 4001 divides an input SAR image into blocks of a predetermined size. The blocking unit 4001 outputs each block obtained by the division to the threshold calculation unit 4002 and the first ship candidate pixel extraction unit 4003. The individual blocks obtained by the division are divided images and can be referred to as block images.

The threshold calculation unit 4002 calculates a threshold value for each block to determine whether a pixel is a ship candidate pixel or not according to the pixel value. Therefore, a threshold value is obtained for each block. The threshold calculation unit 4002 calculates the threshold value for each individual block based on a scattering model of electromagnetic waves at the sea surface (sea surface scattering model of electromagnetic waves). The threshold calculation unit 4002 outputs the threshold values calculated for respective blocks to the first ship candidate pixel extraction unit 4003. Each threshold value calculated by the threshold calculation unit 4002 is used by the first ship candidate pixel extraction unit 4003.

The first ship candidate pixel extraction unit 4003 determines for each block whether each individual pixel in the block is a ship candidate pixel or not, using the threshold value corresponding to the block. Then, for each block, the first ship candidate pixel extraction unit 4003 generates image data in which the pixel value of the pixel determined to be a ship candidate pixel is set to 1 and the pixel value of the pixel determined not to be a ship candidate pixel is set to 0. Each pixel in the image data corresponds to each pixel in the block. This image data is obtained for each block. The first ship candidate pixel extraction unit 4003 outputs the image data generated for each block to the block integration unit 4004.

Hereinafter, a pixel determined to be a ship candidate pixel by the first ship candidate pixel extraction unit 4003 may be referred to as the first ship candidate pixel.

The block integration unit 4004 generates a single image by integrating the image data generated for each block. In this image, the pixel value of the pixel determined to be a ship candidate pixel is 1, and the pixel value of the pixel determined not to be a ship candidate pixel is 0. Therefore, it can be said that this image represents an extraction result of the ship candidate pixel (first ship candidate pixel). In addition, each pixel in this image corresponds to each pixel in the input SAR image. The block integration unit 4004 outputs the generated image (hereinafter, referred to as the integrated image) to the multiple statistics calculation unit 4005 and the ship candidate integration unit 4008.

The multiple statistics calculation unit 4005 regards each individual pixel of the input SAR image as a pixel of interest, and calculates multiple local pixel value statistics for each pixel of interest. Specifically, the multiple statistics calculation unit 4005 changes the cell size of the cell including the pixel of interest, for each pixel of interest, and calculates the pixel value statistic for each cell size. As a result, multiple pixel value statistics are obtained for each individual pixel of interest. The multiple statistics calculation unit 4005 outputs the multiple pixel value statistics calculated for each pixel of interest to the ship index calculation unit 4006.

In other words, the multiple statistics calculation unit 4005 operates in the same way as the multiple statistics calculation unit 2001 (refer to FIG. 2) in the first example embodiment. However, for the cell size corresponding to the cell size of the background cell 53 (the largest cell size) and the cell size corresponding to the cell size of the guard cell 52, the method of calculating a pixel value statistic differs from that that of the first example embodiment. The method of calculating this pixel value statistic will be described later. The method of calculating pixel value statistics for other cell size (i.e., the cell size corresponding to the cell size of target cell 51) is the same as that of calculating a pixel value statistic in the first example embodiment.

The ship index calculation unit 4006 calculates a ship index value for each pixel of interest, which indicates the certainty that the pixel of interest corresponds to a ship, using the plurality of pixel value statistics calculated for the pixel of interest. At this time, the ship index calculation unit 4006 calculates a plurality of ship index values for each individual pixel of interest. The ship index calculation unit 4006 outputs the plurality of ship index values calculated for each pixel of interest to the second ship candidate pixel extraction unit 4007.

The second ship candidate pixel extraction unit 4007 operates in the same way as the ship candidate pixel extraction unit 2003 (refer to FIG. 2) in the first example embodiment. Therefore, the second ship candidate pixel extraction unit 4007 obtains multiple results, for each pixel of interest, to determine whether the pixel of interest is a ship candidate pixel or not. When determining whether a pixel of interest is a ship candidate pixel or not, the second ship candidate pixel extraction unit 4007 uses a predetermined threshold value, as in the first example embodiment. The threshold value calculated for each block by the threshold calculation unit 4002 is not used in the process of the second ship candidate pixel extraction unit 4007. The second ship candidate pixel extraction unit 4007 outputs the multiple determination results obtained for each pixel of interest to the ship candidate integration unit 4008. The pixel determined to be a ship candidate pixel by the second ship candidate pixel extraction unit 4007 may be referred to as a second ship candidate pixel for distinguishing it from the first ship candidate pixel. Since the operation of the second ship candidate pixel extraction unit 4007 is the same as that of the ship candidate pixel extraction unit 2003 in the first example embodiment, a detailed explanation is omitted.

The ship candidate integration unit 4008 integrates, for each pixel of interest, the plurality of determination results obtained with respect to the pixel of interest. Specifically, the ship candidate integration unit 4008 counts the number of times that the pixel of interest is determined to be the second ship candidate pixel for each pixel of interest, and adds up the counting result and the number of times that the pixel of interest is determined to be the first ship candidate pixel. In the second example embodiment, this total result is referred to as a number of ship candidate determinations. The number of ship candidate determinations is obtained for each pixel of interest. The ship candidate integration unit 4008 outputs the number of ship candidate determinations obtained for each pixel of interest to the ship probability calculation unit 4009.

The ship probability calculation unit 4009 calculates the probability that the pixel of interest is a ship-derived pixel (ship probability) for each pixel of interest based on the number of ship candidate determinations. The ship probability calculation unit 4009 outputs the ship probability calculated for each pixel of interest to the ship detection unit 2006.

Hereinafter, more detail description is provided regarding the threshold calculation unit 4002, the first ship candidate pixel extraction unit 4003, the multiple statistics calculation unit 4005, the ship index calculation unit 4006, the ship candidate integration unit 4008, and the ship probability calculation unit 4009.

First, the threshold calculation unit 4002 is explained. As described above, the threshold calculation unit 4002 calculates a threshold value for each block based on the scattering model of electromagnetic waves at the sea surface. This threshold is a threshold used to determine whether a pixel is a ship candidate pixel (first ship candidate pixel) or not.

It is known that the distribution of pixel values at the sea surface in a SAR image follows a generalized gamma distribution. Therefore, when the probability density function of the generalized gamma distribution is set to f_{G-Gamma} and the predetermined false alarm rate is set to PFA, if the threshold t that satisfies equation (15) shown below can be calculated, the threshold τ will be the threshold at which the false alarm rate P_{FA} can be expected.

[Math. 14]

P_{FA}=1.0−∫_{-∞}^{τ}f_{G-Gamma}(x)dx (15)

In other words, the threshold calculation unit 4002 calculates the threshold value that satisfies equation (15) for each block. The threshold value calculated for the j-th block is regarded as τⱼ.

The probability density function f_{PDF} of the generalized gamma distribution is defined as shown in equation (16) below.

$$\begin{matrix}[ Math . 15 ] & \\ {f}_{G - G a m m a} ( x ) = \frac{\vert v \vert {k}^{k}}{σ Γ ( k )} {( \frac{x}{σ} )}^{kv - 1} exp \{ - {k ( \frac{x}{σ} )}^{v} \} & ( 16 )\end{matrix}$$

Each parameter k, σ, v is estimated from N observed data {xi}, i ∈ [1, N], as shown in Reference 1, using the formula shown in equation (17) below.

$$\begin{matrix}[ Math . 16 ] & \\ \{ \begin{matrix}\hat{{c}_{1}} = \frac{1}{N} {\sum }_{i = 1}^{N} ln {x}_{i} \\ \hat{{c}_{2}} = \frac{1}{N} {\sum }_{i = 1}^{N} {( ln {x}_{i} - \hat{{c}_{1}} )}^{2} \\ \hat{{c}_{3}} = \frac{1}{N} {\sum }_{i = 1}^{N} {( ln {x}_{i} - \hat{{c}_{1}} )}^{3}\end{matrix} \\ λ = \frac{\hat{{c}_{2}^{3}}}{\hat{{c}_{3}^{2}}} \\ \{ \begin{matrix}a = \frac{3}{2} - λ \\ b = \frac{3}{4} - 2 λ \\ c = \frac{1}{8} - λ\end{matrix} \\ \{ \begin{matrix}π = b - \frac{{a}^{3}}{3} \\ ϕ = \frac{2}{27} {a}^{3} - \frac{a b}{3} + c\end{matrix} \\ \{ \begin{matrix}k = - \frac{a}{3} + \sqrt[3]{- \frac{ϕ}{2} + \sqrt{{( \frac{ϕ}{2} )}^{2} + {( \frac{π}{3} )}^{3}}} + \sqrt[3]{- \frac{ϕ}{2} - \sqrt{{( \frac{ϕ}{2} )}^{2} + {( \frac{π}{3} )}^{3}}} \\ v = s g n ( - \hat{{c}_{3}} ) \sqrt{\frac{Ψ ( 1 , k )}{\hat{{c}_{2}}}} \\ σ = exp \{ \hat{{c}_{1}} - \frac{Ψ ( k ) - ln k}{v} \}\end{matrix} & ( 17 )\end{matrix}$$

It should be noted that sgn(⋅) denotes a function that represents the sign, Ψ(⋅) denotes a digamma function, Ψ(m, ⋅) denotes a polygamma function.
[Reference 1]

Heng-Chao Li, Wen Hong, Yi-Rong Wu, Ping-Zhi Fan, “On the Empirical-Statistical Modeling of SAR Images with Generalized Gamma Distribution,” IEEE JOURNAL OF SELECTED TOPICS IN SIGNAL PROCESSING, VOL. 5, NO. 3, JUNE 2011

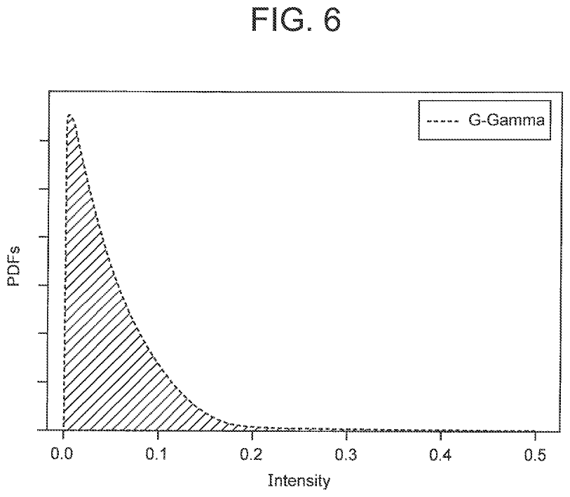

An example of fitting the pixel value distribution of the sea surface with the generalized gamma distribution is shown in FIG. 6.

The distribution used to calculate the threshold value based on the scattering model of electromagnetic waves at the sea surface (sea surface scattering model of electromagnetic waves) is not limited to the generalized gamma distribution, and other distributions such as the K-distribution or Weibull distribution may be used.

Next, the first ship candidate pixel extraction unit 4003 is explained. As described above, the first ship candidate pixel extraction unit 4003 determines, for each block, whether an individual pixel in the block is a ship candidate pixel or not, using a threshold corresponding to the block. Each block is obtained by dividing the SAR image by the blocking unit 4001. The threshold value corresponding to a block is the threshold value calculated for each block by the threshold calculation unit 4002.

The j-th block is defined as Bⱼ and the threshold corresponding to the j-th block is defined as τᵢ. The pixel corresponding to position (x,y), which is represented by a binary pixel value depending on whether the pixel in the block corresponding to that pixel is a ship candidate pixel or not, is denoted as O_{G-Gamma(j)}(x,y). j is the index number of that block. The pixel value of the pixel in the block corresponding to the position (x,y) is denoted as Bⱼ(x,y). When the pixel value Bⱼ(x,y) of a pixel in the block corresponding to the position (x,y) is larger than the threshold τⱼ corresponding to the block, the first ship candidate pixel extraction unit 4003 determines that the pixel is a ship candidate pixel. When the pixel value Bⱼ(x,y) of the pixel in the block corresponding to the position (x,y) is less than or equal to the threshold τⱼ corresponding to the block, the first ship candidate pixel extraction unit 4003 determines that the pixel is not a ship candidate pixel. Specifically, the first ship candidate pixel extraction unit 4003 determines the value of O_{G-Gamma(j)}(x,y) according to the following equation (18).

$$\begin{matrix}[ Math . 17 ] & \\ {O}_{G - Gamma ( j )} ( x , y ) = \{ \begin{matrix}1 & {B}_{j} ( x , y ) > {τ}_{j} \\ 0 & otherwise\end{matrix} & ( 18 )\end{matrix}$$

The first ship candidate pixel extraction unit 4003 performs this process for each individual pixel in each individual block, and summarizes the set of O_{G-Gamma(j)}(x,y) for each block.

The set of O_{G-Gamma(j)}(x,y) obtained for a single block is a binary image in which a ship candidate pixel is represented by 1 and a non-ship candidate pixel is represented by 0. Additionally, the set of O_{G-Gamma(j)}(x,y) obtained for a single block corresponds to the image data described above.

The binary image (image data) with ship candidate pixels represented by 1 and non-ship candidate pixels represented by 0 for each block is obtained by the processing of the first ship candidate pixel extraction unit 4003.

As described above, the block integration unit 4004 generates a single image (integrated image) by integrating the image data generated for each block. In this image, the pixel value of the pixel determined to be a ship candidate pixel is 1, and the pixel value of the pixel determined not to be a ship candidate pixel is 0.

Next, the multiple statistics calculation unit 4005 is explained. As described above, the multiple statistics calculation unit 4005 changes the cell size of the cell including the pixel of interest, for each pixel of interest, and calculates the pixel value statistic for each cell size. As a result, multiple pixel value statistics are obtained for each individual pixel of interest.

The method of calculating pixel value statistics with respect to cell size other than the cell size corresponding to the cell size of background cell 53 (the largest cell size) and the cell size corresponding to the cell size of guard cell 52 is the same as the method of calculating pixel value statistics in the first example embodiment. In other words, the method of calculating the pixel value statistic with respect to the cell size corresponding to the cell size of the target cell 51 is the same as the method of calculating the pixel value statistic in the first example embodiment. Therefore, the multiple statistics calculating unit 4005 may perform the process of calculating the pixel value statistic by equation (1) or equation (5) for each cell size, for each pixel of interest.

It is described how the multiple statistics calculation unit 4005 calculates the pixel value statistic according to the cell size corresponding to the cell size of the background cell 53 and the pixel value statistic according to the cell size corresponding to the cell size of the guard cell 52.

The pixel value of the pixel at position (x,y) in the integrated image is denoted as O_{G-Gamma}(x,y). The cell size corresponding to the cell size of the background cell 53 is denoted as W_{bgr}. Further, W_{bgr}′=(w_{bgr}−1)/2 is defined. Similarly, the cell size corresponding to the cell size of the guard cell 52 is denoted as w_{grd}. Furthermore, w_{grd}′=(w_{grd}−1)/2 is defined.

When the pixel value statistic corresponding to the cell size w_{bgr} is calculated by a box filter process to obtain the local pixel value average, the multiple statistics calculating unit 4005 calculates the pixel value statistic U_{bgr} by the calculation of equation (19a) shown below. When the pixel value statistic corresponding to the cell size w_{grd} is calculated by a box filter process to obtain the local pixel value average, the multiple statistic calculation unit 4005 calculates the pixel value statistic U_{grd} by the calculation of equation (19b) shown below. The position of the pixel of interest is regarded as (x,y).

[Math. 18]

U_{brg}(x,y)=Σ_{n=y-w′}_{_{bgr}}^{y+w′}^{_{bgr}}Σ_{m=x-w′}_{_{bgr}}^{x+w′}^{_{bgr}}O_{G-Gamma}(m,n)×S(m,n) (19a)

U_{grd}(x,y)=Σ_{n=y-w′}_{_{grd}}^{y+w′}^{_{grd}}Σ_{m=x-w′}_{_{grd}}^{x+w′}^{_{grd}}O_{G-Gamma}(m,n)×S(m,n) (19b)

The multiple statistics calculation unit 4005 calculates the pixel value statistic U_{bgr} corresponding to the cell size w_{bgr} for each pixel of interest by calculating the equation (19a). Further, the multiple statistics calculation unit 4005 calculates the pixel value statistic U_{grd} corresponding to the cell size w_{grd} for each pixel of interest by the calculation of equation (19b).

The multiple statistics calculating unit 4005 may calculate the pixel value statistic corresponding to the cell size w_{bgr} by a box filter process to obtain the local variance of pixel values. In this case, the multiple statistics calculating unit 4005 calculates the pixel value statistic V_{bgr} by calculating the equation (20a) shown below. Further, when the multiple statistics calculating unit 4005 calculates the pixel value statistic corresponding to the cell size w_{grd} by the box filter process to obtain the local variance of pixel values, the multiple statistics calculation unit 4005 calculates the pixel value statistic V_{grd} by the calculation of equation (20b) shown below. The position of the pixel of interest is assumed to be (x,y).

[Math. 19]

V_{brg}(x,y)=Σ_{n=y-w′}_{_{bgr}}^{y+w′}^{_{bgr}}Σ_{m=x-w′}_{_{bgr}}^{x+w′}^{_{bgr}}O_{G-Gamma}(m,n)×S(m,n)×S(m,n)_ (20a)

V_{grd}(x,y)=Σ_{n=y-w′}_{_{grd}}^{y+w′}^{_{grd}}Σ_{m=x-w′}_{_{grd}}^{x+w′}^{_{grd}}O_{G-Gamma}(m,n)×S(m,n)×S(m,n) (20b)

The multiple statistics calculation unit 4005 calculates the pixel value statistic V_{bgr} corresponding to the cell size w_{bgr} for each pixel of interest by the calculation of equation (20a). The multiple statistics calculation unit 4005 calculates the pixel value statistic V_{grd} corresponding to the cell size w_{grd} for each pixel of interest by the calculation of equation (20b).

The normalization term of the filter processing result corresponding to the cell size w_{bgr} is defined as ω_{bgr}. The multiple statistics calculation unit 4005 calculates the above normalization term ω_{bgr} at the pixel of interest by calculating equation (21a) shown below. Further, the normalization term of the filter processing result corresponding to the cell size w_{grd} is defined as ω_{g}rd. The multiple statistics calculation unit 4005 calculates the above normalization term ω_{grd} at the pixel of interest by calculating equation (21b) shown below. The position of the pixel of interest is assumed to be (x,y).

[Math. 20]

ω_{brg}(x,y)=Σ_{n=y-w′}_{_{bgr}}^{y+w′}^{_{bgr}}Σ_{m=x-w′}_{_{bgr}}^{x+w′}^{_{bgr}}O_{G-Gamma}(m,n) (21a)

ω_{grd}(x,y)=Σ_{n=y-w′}_{_{grd}}^{y+w′}^{_{grd}}Σ_{m=x-w′}_{_{grd}}^{x+w′}^{_{grd}}O_{G-Gamma}(m,n) (21b)

The multiple statistics calculation unit 4005 calculates the normalization term ω_{bgr} for each pixel of interest by calculating equation (21a). The multiple statistics calculation unit 4005 calculates the normalization term ω_{grd} for each pixel of interest by calculating equation (21b).

Next, the ship index calculation unit 4006 is explained. As described above, the ship index calculation unit 4006 calculates the ship index value for each pixel of interest using the plurality of pixel value statistics calculated for the pixel of interest. At this time, the ship index calculation unit 4006 calculates a plurality of ship index values for each individual pixel of interest.

The ship index calculation unit 4006 calculates the pixel value statistic of the target cell 51 and the pixel value statistic of the background cell 53 using the pixel value statistics calculated for the plurality of cell sizes with respect to the pixel of interest. In this example embodiment, the ship index calculation unit 4006 calculates the mean pixel value as the pixel value statistics of the target cell 51 and the background cell 53. The ship index calculation unit 4006 may also calculate the variance value of pixel values in addition to the mean pixel value as the pixel value statistic of the background cell 53.

The cell size of the target cell 51 is denoted as wₜₐᵣ, the cell size of the guard cell 52 is denoted as w_{grd}, and the cell size of the background cell 53 is denoted as w_{bgr}.

The result of the box filtering process, corresponding to the cell size of the target cell 51, to obtain the pixel value average is regarded as Uₜₐᵣ. Similarly, the result of the box filtering process, corresponding to the cell size of the guard cell 52, to obtain the pixel value average is regarded as U_{bgr}.

The result of the box filtering process, corresponding to the cell size of the guard cell 52, to obtain the local variance of pixel values is regarded as V_{grd}. Similarly, the result of the box filtering process, corresponding to the cell size of the background cell 53, to obtain the local variance of pixel values is V_{bgr}.

The ship index calculation unit 4006 calculates the pixel value statistic of the target cell 51 (specifically, the mean pixel value μₜₐᵣ of the target cell 51) using the equation (22) shown below.

[Math. 21]

μₜₐᵣ=Uₜₐᵣ/(wₜₐᵣ×wₜₐᵣ) (22)

The ship index calculation unit 4006 calculates the pixel value statistic of the background cell 53 (specifically, the mean pixel value μ_{bgr} of the background cell 53) using the equation (23) shown below.

[Math. 22]

μ_{bgr}=(U_{bgr}−U_{grd})/(ω_{bgr}−ω_{grd}) (23)

If the variance value of pixel values is also calculated as a pixel value statistic of the background cell 53, the ship index calculation unit 4006 calculates the variance value σ_{bgr}² of pixel values of the background cell 53 by the equation (24) shown below.

[Math. 23]

σ_{bgr}²=(V_{bgr}−V_{grd})/(ω_{bgr}−ω_{grd})−μ_{bgr}² (24)

The ship index calculation unit 4006 calculates a ship index value for the pixel of interest using the mean pixel value μₜₐᵣ of the target cell 51 and the mean pixel value μ_{bgr} of the background cell 53 calculated as described above (the variance value σ_{bgr}² of the pixel values of the background cell 53 may be also used.).

The process of calculating the ship index value after calculating μₜₐᵣ, μ_{bgr}, and σ_{bgr}² is the same as that in the first example embodiment. That is, the ship index calculation unit 4006 may calculate the ship index value I_{CA-CFAR} by calculating I_{CA-CFAR}=μₜₐᵣ/μ_{bgr}. Alternatively, the ship index calculation unit 4006 may calculate the ship index value I_{TP-CFAR} by calculating I_{TP-CFAR}=(μₜₐᵣ−μ_{bgr})/σ_{bgr}.

Then, for one cell of interest, the ship index calculation unit 4006 calculates M ship index values I_{CA-CFAR(h)}, h=1, 2, . . . , M, or I_{TP-CFAR(h)}, h=1, 2, . . . , M by repeating the above process while changing the cell size of the target cell 51 and the cell size of the guard cell 52. At this time, the cell size of the background cell 53 may be set to a certain value or may be changed in the same way as the cell sizes of the target cell 51 and the guard cell 52. “h” is an index number of the combination of the cell sizes of the target cell 51 and the cell size of the guard cell 52. Here, the number of combinations of the cell size of the target cell 51 and the cell size of the guard cell 52 is set to M.

The ship index calculation unit 4006 performs the process of calculating M ship index values for each individual pixel of interest.

The ship index calculation unit 4006 may calculate both I_{CA-CFAR(h)}, h=1, 2, . . . , M, and I_{TP-CFAR(h)}, h=1, 2, . . . , M, in the above process.

As described above, since the operation of the second ship candidate pixel extraction unit 4007 is the same as that of the ship candidate pixel extraction unit 2003 in the first example embodiment, a detailed explanation is omitted. The second ship candidate pixel extraction unit 4007 determines the value of O_{CA-CFAR(h)}(x,y) according to the aforementioned equation (9) for each pixel of interest, for each case from h=1 to h=M. Alternatively, the second ship candidate pixel extraction unit 4007 determines the value of O_{TP-CFAR(h)}(x,y) according to the aforementioned equation (10) for each pixel of interest, for each of the cases from h=1 to h=M.

Next, the ship candidate integration unit 4008 is explained. As described above, the ship candidate integration unit 4008 integrates a plurality of determination results obtained with respect to the pixel of interest, for each pixel of interest. Specifically, the ship candidate integration unit 4008 counts the number of times that the pixel of interest is determined to be the second ship candidate pixel by the second ship candidate pixel extraction unit 4007, and adds up the counting results and the number of times that the number of times the pixel of interest is determined to be the first ship candidate pixel by the first ship candidate pixel extraction unit 4003, for each pixel of interest. In the second example embodiment, this total result is referred to as a number of ship candidate determinations. The number of times that the pixel of interest is determined to be the first ship candidate pixel by the first ship candidate pixel extraction unit 4003 is 0 or 1, for one pixel of interest.

First, the case is explained where the second ship candidate pixel extraction unit 4007 determines the value of O_{CA-CFAR(h)}(x,y) for each case from h=1 to h=M. In this case, the ship candidate integration unit 4008 determines the number of ship candidate determinations C by calculating equation (25) shown below.

[Math. 24]

C=O_{G-Gamma}(x,y)+ΣO_{CA-CFAR(h)} (25)

In equation (25), if O_{G-Gamma}(x,y)=1, it means that the pixel of interest is determined to be a ship candidate pixel by the first ship candidate pixel extraction unit 4003. If O_{G-Gamma}(x,y)=0, it means that the pixel of interest is determined as not a ship candidate pixel by the first ship candidate pixel extraction unit 4003. This is also true for equation (26) and equation (27) described below.

The ship candidate integration unit 4008 performs the process of obtaining the number of ship candidate determinations C using equation (25) for each pixel of interest.

The same applies to the case where the second ship candidate pixel extraction unit 4007 determines the value of O_{TP-CFAR(h)}(x,y) for each case from h=1 to h=M. In other words, the ship candidate integration unit 4008 determines the number of ship candidate determinations C by calculating equation (26) as shown below.

[Math. 25]

C=O_{G-Gamma}(x,y)+ΣO_{TP-CFAR(h)} (26)

The ship candidate integration unit 4008 performs the process of obtaining the number of ship candidate determinations C according to equation (26) for each pixel of interest.

When the second ship candidate pixel extraction unit 4007 determines both the value of O_{CA-CFAR(h)}(x,y) and the value of O_{TP-CFAR(h)}(x,y) for each case from h=1 to h=M, the ship candidate integration unit 4008 calculates the number of ship candidate determinations C by the following equation (27) below.

[Math. 26]

C=O_{G-Gamma}(x,y)+ΣO_{CA-CFAR(h)}+ΣO_{TP-CFAR(h)} (27)

In this case, too, the ship candidate integration unit 4008 performs the process of determining the number of ship candidate determinations C by equation (27) for each pixel of interest.

Next, the ship probability calculation unit 4009 is explained. As described above, the ship probability calculation unit 4009 calculates the probability that the pixel of interest is a ship-derived pixel (ship probability) based on the number of ship candidate determinations, for each pixel of interest.

The ship probability calculation unit 4009 calculates the ship probability by normalizing the number of ship candidate determinations C obtained by the ship candidate integration unit 4008.

For example, suppose that the ship candidate integration unit 4008 calculates the number of ship candidate determinations C using equation (25) or equation (26). In this case, in the second example embodiment, the ship probability calculation unit 4009 obtains the ship probability P by calculating P=C/(M+1). The ship probability calculation unit 4009 executes the process of calculating the ship probability P for each pixel of interest.

For example, suppose that the ship candidate integration unit 4008 calculates the number of ship candidate determinations C using equation (27). In this case, the ship probability calculation unit 4009 obtains the ship probability P by calculating P=C/(2M+1). In this case, too, the ship probability calculation unit 4009 executes the process of calculating the ship probability P for each pixel of interest.

The ship probability calculation unit 4009 may apply kernel density estimation to the calculation of the ship probability P, similar to the ship probability calculation unit 2005 in the first example embodiment.

The image processing unit 2, which includes the blocking unit 4001, the threshold calculation unit 4002, the first ship candidate pixel extraction unit 4003, the block integration unit 4004, the multiple statistics calculation unit 4005, the ship index calculation unit 4006, the second ship candidate pixel extraction unit 4007, the ship candidate integration unit 4008, the ship probability calculation unit 4009, and the ship detection unit 2006, is realized, for example, by a CPU of a computer that operates according to a ship detection program. In this case, for example, the CPU may read the ship detection program from a program recording medium such as a program storage device of the computer, and operate as the image processing unit 2 including the blocking unit 4001, the threshold calculation unit 4002, the first ship candidate pixel extraction unit 4003, the block integration unit 4004, the multiple statistics calculation unit 4005, ship index calculation unit 4006, second ship candidate pixel extraction unit 4007, ship candidate integration unit 4008, ship probability calculation unit 4009, and ship detection unit 2006, according to the ship detection program.

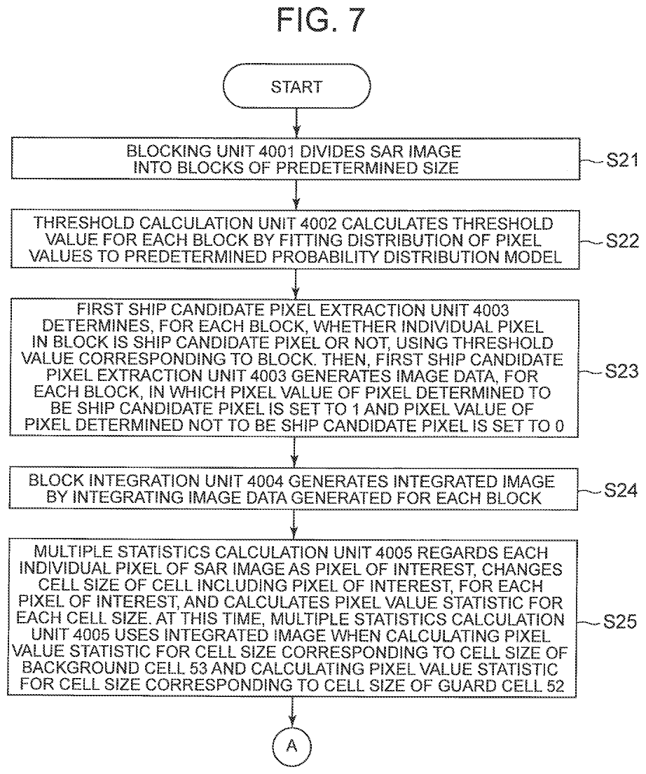

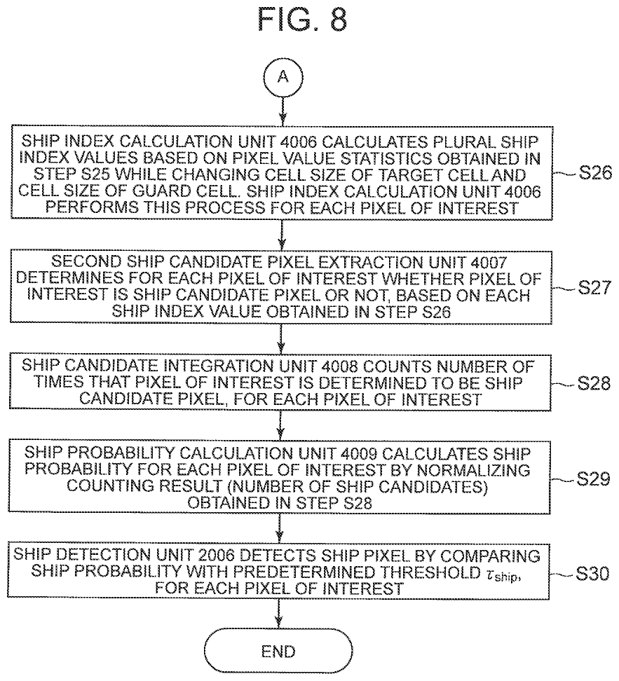

FIGS. 7 and 8 are flowcharts showing an example of the process of the image processing unit 2 of the second example embodiment. The matters already explained are omitted as appropriate.

First, the blocking unit 4001 divides an input SAR image into blocks of a predetermined size (step S21).

Next, the threshold calculation unit 4002 calculates a threshold value for each block by fitting the distribution of pixel values to a predetermined probability distribution model (step S22).

Next, the first ship candidate pixel extraction unit 4003 determines, for each block, whether an individual pixel in the block is a ship candidate pixel or not, using the threshold value corresponding to the block. Then, the first ship candidate pixel extraction unit 4003 generates image data, for each block, in which the pixel value of the pixel determined to be a ship candidate pixel is set to 1 and the pixel value of the pixel determined not to be a ship candidate pixel is set to 0 (step S23).

Next, the block integration unit 4004 generates an integrated image by integrating the image data generated for each block (step S24).

Next, the multiple statistics calculation unit 4005 regards each individual pixel of the input SAR image as a pixel of interest, changes the cell size of the cell including the pixel of interest, for each pixel of interest, and calculates the pixel value statistic for each cell size. At this time, the multiple statistics calculation unit 4005 uses the integrated image when calculating the pixel value statistic for the cell size corresponding to the cell size of the background cell 53 and calculating the pixel value statistic for the cell size corresponding to the cell size of the guard cell 52 (step S25). As a result of step S25, multiple pixel value statistics are obtained for each individual pixel of interest.

Next, the ship index calculation unit 4006 calculates a plurality of ship index values based on the pixel value statistics obtained in step S25 while changing the cell size of the target cell and the cell size of the guard cell. The ship index calculation unit 4006 performs this process for each pixel of interest (step S26).

Next, the second ship candidate pixel extraction unit 4007 determines for each pixel of interest whether the pixel of interest is a ship candidate pixel or not, based on each ship index value obtained in step S26 (step S27). As a result of step S27, multiple determination results are obtained for each pixel of interest.

Next, the ship candidate integration unit 4008 counts a number of times that the pixel of interest is determined to be a ship candidate pixel, for each pixel of interest (step S28).

Next, the ship probability calculation unit 4009 calculates the ship probability for each pixel of interest by normalizing the counting result (number of ship candidates) obtained in step S28 (step S29).

Next, the ship detection unit 2006 detects a ship pixel by comparing the ship probability with a predetermined threshold τₛₕᵢₚ, for each pixel of interest (step S30). The ship detection unit 2006 outputs information indicating the ship pixel in the SAR image (for example, information indicating a position of the ship pixel in the SAR image) to the result output unit 3.

When the process of the ship detection unit 2006 is completed, the process of the image processing unit 2 is finished.

The result output unit 3, for example, outputs a SAR image in which pixels corresponding to a ship are highlighted as the ship. However, the output format by the result output unit 3 is not limited to this example.

This example embodiment has the same effect as that of the first example embodiment.

Furthermore, in this example embodiment, the multiple statistics calculation unit 4005 calculates the pixel value statistic U_{bgr}, the pixel value statistic V_{bgr}, and the normalization term ω_{bgr} by using the integrated image and according to calculation of the aforementioned equation (19a), equation (20a), and equation (21a). The multiple statistics calculation unit 4005 calculates the pixel value statistic U_{grd}, the pixel value statistic V_{grd}, and the normalization term ω_{grd} by using the integrated image and according to calculation of the aforementioned equation (19b), equation (20b), and equation (21b). Then, the ship index calculation unit 4006 calculates the pixel value feature quantity of the background cell 53 by using those values and according to calculation of equation (23) and equation (24). This operation results in the calculation of the pixel value feature quantity of the background cell 53, while excluding pixels detected as ship candidate pixels in the background cell 53 by the first ship candidate pixel extraction unit 4003. Therefore, the degradation of ship detection performance due to the presence of other ships in the area corresponding to the background cell 53 can be suppressed. Therefore, it is possible to detect ships more stably from a SAR image.

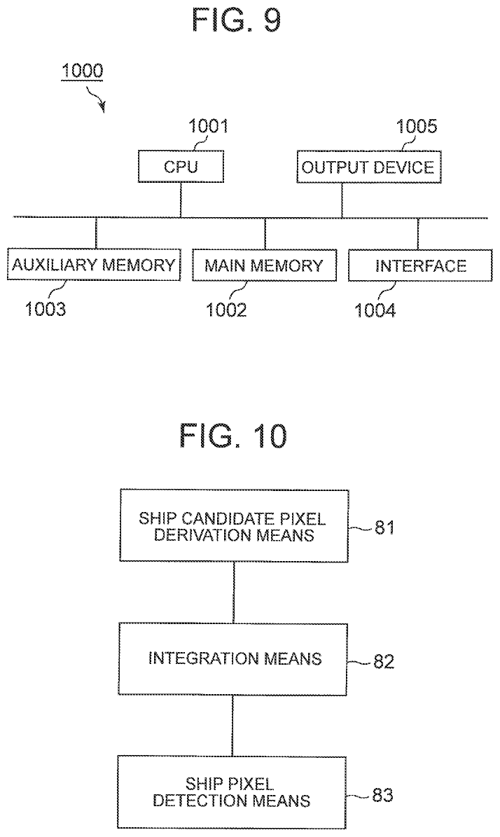

FIG. 9 is a schematic block diagram of a computer configuration for a ship detection system in each example embodiment. The computer 1000 has a CPU 1001, a main memory 1002, an auxiliary memory 1003, an interface 1004, and an output device 1005.

The ship detection system of each example embodiment is implemented in a computer 1000, the operation of that is stored in an auxiliary memory 1003 in the form of a ship detection program. The CPU 1001 reads the ship detection program from the auxiliary memory 1003, develops it in the main memory 1002, and executes the operations described in the above example embodiments according to the ship detection program.

The auxiliary memory 1003 is an example of a non-transitory tangible medium. Other examples of non-transitory tangible media are a magnetic disk, an optical magnetic disk, a CD-ROM (Compact Disk Read Only Memory), a DVD-ROM (Digital Versatile Disk Read Only Memory), a semiconductor memory, and the like, which are connected through the interface 1004. When the program is delivered to the computer 1000 through a communication line, the computer 1000 that receives the delivery may develop the program into the main memory 1002 and execute the above process.

The program may also be a program for realizing part of the aforementioned processing. Further, the program may be a difference program that realizes the aforementioned processing in combination with other programs already stored in the auxiliary memory 1003.

Some or all of the components may be realized by general-purpose or dedicated circuitry, processors, or a combination of these. They may be configured by a single chip or by multiple chips connected through a bus. Some or all of the components may be realized by a combination of the above-mentioned circuits, etc. and a program.

When some or all of each component is realized by multiple information processing devices, circuits, etc., the multiple information processing devices, circuits, etc. may be centrally located or distributed. For example, the information processing devices, circuits, etc. may be implemented as a client-and-server system, cloud computing system, etc., each of which is connected via a communication network.

Next, a summary of the present invention will be described. FIG. 10 shows a block diagram of a summarized example of a ship detection system according to the present invention. The ship detection system of the present invention comprises ship candidate pixel derivation means 81, integration means 82, and ship pixel detection means 83.

The ship candidate pixel derivation means 81 (for example, the part corresponding to the multiple statistics calculation unit 2001, the ship index calculation unit 2002, and the ship candidate pixel extraction unit 2003, or the part corresponding to the multiple statistics calculation unit 4005, the ship index calculation unit 4006, and the second ship candidate pixel extraction unit 4007) regards each individual pixel of an input synthetic aperture radar image as a pixel of interest, and determines, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell.

The integration method 82 (for example, the part corresponding to the ship candidate integration unit 2004 or the part corresponding to the ship candidate integration unit 4008) integrates a plurality of determination results of whether the pixel of interest is the ship candidate pixel or not, for each pixel of interest.

The ship pixel detection means 83 (for example, the part corresponding to the ship probability calculation unit 2005 and the ship detection unit 2006, or the part corresponding to the ship probability calculation unit 4009 and the ship detection unit 2006) detects the pixel corresponding to the ship, based on integration results obtained for each pixel of interest by the integration means 82.

Such a configuration allows for the stable detection of ships of various sizes.

The aforementioned example embodiments can be described as supplementary notes mentioned below, but are not limited to the following supplementary notes.

(Supplemental note 1) A ship detection system comprising:

ship candidate pixel derivation means which regards each individual pixel of an input synthetic aperture radar image as a pixel of interest, and determines, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell,

integration means which integrates a plurality of determination results of whether the pixel of interest is the ship candidate pixel or not, for each pixel of interest, and

ship pixel detection means which detects the pixel corresponding to the ship, based on integration results obtained for each pixel of interest by the integration means.

(Supplemental note 2) The ship detection system according to Supplementary note 1, wherein

the ship candidate pixel derivation means calculates a pixel value statistic of the target cell and a pixel value statistic of the background cell, for each combination of the cell size of the target cell and the cell size of the guard cell, and determines whether the pixel of interest is the ship candidate pixel or not, based on a relationship between the pixel value statistic of the target cell and the pixel value statistic of the background cell, for each pixel of interest.

(Supplemental note 3) The ship detection system according to Supplementary note 1 or 2, further comprising

constant false alarm rate processing means which detects the ship candidate pixel from the synthetic aperture radar image, based on a relationship between a sea surface scattering model of electromagnetic wave and a predetermined false alarm rate.

(Supplemental note 4) The ship detection system according to Supplementary note 2, further comprising

constant false alarm rate processing means which detects the ship candidate pixel from the synthetic aperture radar image, based on a relationship between a sea surface scattering model of electromagnetic wave and a predetermined false alarm rate,

wherein the ship candidate pixel derivation means calculates the pixel value statistic of the background cell, while excluding the pixel detected as the ship candidate pixel by the constant false alarm rate processing means.

(Supplemental note 5) The ship detection system according to one of Supplementary notes 1 to 4, wherein

the integration means integrates the plurality of determination results of whether the pixel of interest is the ship candidate pixel or not, by counting a number of times that the pixel of interest is determined to be the ship candidate pixel, for each pixel of interest.

(Supplemental note 6) A ship detection method implemented by a computer, comprising:

executing a ship candidate pixel derivation process of regarding each individual pixel of an input synthetic aperture radar image as a pixel of interest, and determining, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell,

executing an integration process of integrating a plurality of determination results of whether the pixel of interest is the ship candidate pixel or not, for each pixel of interest, and

executing a ship pixel detection process of detecting the pixel corresponding to the ship, based on integration results obtained for each pixel of interest in the integration process.

(Supplemental note 7) The ship detection method according to Supplementary note 6, wherein

in the ship candidate pixel derivation process, a pixel value statistic of the target cell and a pixel value statistic of the background cell are calculated by the computer, for each combination of the cell size of the target cell and the cell size of the guard cell, and whether the pixel of interest is the ship candidate pixel or not is determined by the computer, based on a relationship between the pixel value statistic of the target cell and the pixel value statistic of the background cell, for each pixel of interest.

(Supplemental note 8) The ship detection method according to Supplementary note 6 or 7, wherein

a constant false alarm rate process of detecting the ship candidate pixel from the synthetic aperture radar image is executed by the computer, based on a relationship between a sea surface scattering model of electromagnetic wave and a predetermined false alarm rate.

(Supplemental note 9) The ship detection method according to Supplementary note 7,

wherein a constant false alarm rate process of detecting the ship candidate pixel from the synthetic aperture radar image is executed by the computer, based on a relationship between a sea surface scattering model of electromagnetic wave and a predetermined false alarm rate,

and wherein in the ship candidate pixel derivation process, the pixel value statistic of the background cell are calculated by the computer, while excluding the pixel detected as the ship candidate pixel in the constant false alarm rate process.

(Supplemental note 10) The ship detection method according to one of Supplementary notes 6 to 9, wherein

in the integration process, the plurality of determination results of whether the pixel of interest is the ship candidate pixel or not are integrated by the computer, by counting a number of times that the pixel of interest is determined to be the ship candidate pixel, for each pixel of interest.

(Supplemental note 11) A ship detection program causing a computer to execute:

a ship candidate pixel derivation process of regarding each individual pixel of an input synthetic aperture radar image as a pixel of interest, and determining, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell,

an integration process of integrating a plurality of determination results of whether the pixel of interest is the ship candidate pixel or not, for each pixel of interest, and

a ship pixel detection process of detecting the pixel corresponding to the ship, based on integration results obtained for each pixel of interest in the integration process.

(Supplementary note 12) The ship detection program according to Supplementary note 11, causing the computer to execute:

in the ship candidate pixel derivation process, calculating a pixel value statistic of the target cell and a pixel value statistic of the background cell, for each combination of the cell size of the target cell and the cell size of the guard cell, and determining whether the pixel of interest is the ship candidate pixel or not, based on a relationship between the pixel value statistic of the target cell and the pixel value statistic of the background cell, for each pixel of interest.

(Supplemental note 13) The ship detection program according to Supplementary note 11 or 12, causing the computer to execute:

a constant false alarm rate process of detecting the ship candidate pixel from the synthetic aperture radar image, based on a relationship between a sea surface scattering model of electromagnetic wave and a predetermined false alarm rate.

(Supplementary note 14) The ship detection program according to Supplementary note 12, causing the computer to execute:

a constant false alarm rate process of detecting the ship candidate pixel from the synthetic aperture radar image, based on a relationship between a sea surface scattering model of electromagnetic wave and a predetermined false alarm rate, and

wherein in the ship candidate pixel derivation process, the pixel value statistic of the background cell are calculated, while excluding the pixel detected as the ship candidate pixel in the constant false alarm rate process.

(Supplemental note 15) The ship detection program according to one of Supplementary notes 11 to 14, causing the computer to execute:

in the integration process, integrating the plurality of determination results of whether the pixel of interest is the ship candidate pixel or not, by counting a number of times that the pixel of interest is determined to be the ship candidate pixel, for each pixel of interest.

While the present invention has been described with reference to the example embodiments, the present invention is not limited to the aforementioned example embodiments. Various changes understandable to those skilled in the art within the scope of the present invention can be made to the structures and details of the present invention.

### INDUSTRIAL APPLICABILITY

The present invention is suitably applied to the detection of ships from a SAR image.

### REFERENCE SIGNS LIST

1 image holding unit

2 image processing unit

3 result output unit

2001, 4005 multiple statistics calculation unit

2002, 4006 ship index calculation unit

2003 ship candidate pixel extraction unit

2004, 4008 ship candidate integration unit

2005, 4009 ship probability calculation unit

2006 ship detection unit

4001 blocking unit

4002 threshold calculation unit

4003 first ship candidate pixel extraction unit

4004 block integration unit

4007 second ship candidate pixel extraction unit

What is claimed is:

1. A ship detection system comprising:
a ship candidate pixel derivation unit which regards each individual pixel of an input synthetic aperture radar image as a pixel of interest, and determines, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell,
an integration unit which integrates a plurality of determination results of whether the pixel of interest is the ship candidate pixel or not, for each pixel of interest, and
a ship pixel detection unit which detects the pixel corresponding to the ship, based on integration results obtained for each pixel of interest by the integration unit.

2. The ship detection system according to claim 1, wherein
the ship candidate pixel derivation unit calculates a pixel value statistic of the target cell and a pixel value statistic of the background cell, for each combination of the cell size of the target cell and the cell size of the guard cell, and determines whether the pixel of interest is the ship candidate pixel or not, based on a relationship between the pixel value statistic of the target cell and the pixel value statistic of the background cell, for each pixel of interest.

3. The ship detection system according to claim 1, further comprising a constant false alarm rate processing unit which detects the ship candidate pixel from the synthetic aperture radar image, based on a relationship between a sea surface scattering model of electromagnetic wave and a predetermined false alarm rate.

4. The ship detection system according to claim 2, further comprising
a constant false alarm rate processing unit which detects the ship candidate pixel from the synthetic aperture radar image, based on a relationship between a sea surface scattering model of electromagnetic wave and a predetermined false alarm rate,
wherein the ship candidate pixel derivation unit calculates the pixel value statistic of the background cell, while excluding the pixel detected as the ship candidate pixel by the constant false alarm rate processing unit.

5. The ship detection system according to claim 1, wherein
the integration unit integrates the plurality of determination results of whether the pixel of interest is the ship candidate pixel or not, by counting a number of times that the pixel of interest is determined to be the ship candidate pixel, for each pixel of interest.

6. A ship detection method implemented by a computer, comprising:
executing a ship candidate pixel derivation process of regarding each individual pixel of an input synthetic aperture radar image as a pixel of interest, and determining, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell,
executing an integration process of integrating a plurality of determination results of whether the pixel of interest is the ship candidate pixel or not, for each pixel of interest, and
executing a ship pixel detection process of detecting the pixel corresponding to the ship, based on integration results obtained for each pixel of interest in the integration process.

7. The ship detection method according to claim 6, wherein
in the ship candidate pixel derivation process, a pixel value statistic of the target cell and a pixel value statistic of the background cell are calculated by the computer, for each combination of the cell size of the target cell and the cell size of the guard cell, and whether the pixel of interest is the ship candidate pixel or not is determined by the computer, based on a relationship between the pixel value statistic of the target cell and the pixel value statistic of the background cell, for each pixel of interest.

8. The ship detection method according to claim 6, wherein
a constant false alarm rate process of detecting the ship candidate pixel from the synthetic aperture radar image is executed by the computer, based on a relationship between a sea surface scattering model of electromagnetic wave and a predetermined false alarm rate.

9. The ship detection method according to claim 7,
wherein a constant false alarm rate process of detecting the ship candidate pixel from the synthetic aperture radar image is executed by the computer, based on a relationship between a sea surface scattering model of electromagnetic wave and a predetermined false alarm rate,
and wherein in the ship candidate pixel derivation process, the pixel value statistic of the background cell are calculated by the computer, while excluding the pixel detected as the ship candidate pixel in the constant false alarm rate process.

10. The ship detection method according to claim 6, wherein
in the integration process, the plurality of determination results of whether the pixel of interest is the ship candidate pixel or not are integrated by the computer, by counting a number of times that the pixel of interest is determined to be the ship candidate pixel, for each pixel of interest.

11. A non-transitory computer-readable recording medium in which a ship detection program is recorded, the ship detection program causing a computer to execute:
a ship candidate pixel derivation process of regarding each individual pixel of an input synthetic aperture radar image as a pixel of interest, and determining, for each pixel of interest, whether or not the pixel of interest is a ship candidate pixel which is a candidate of a pixel representing a ship, for each combination of a cell size of a target cell including the pixel of interest and a cell size of a guard cell that corresponds to an area between a background cell including pixels around the target cell and the target cell,
an integration process of integrating a plurality of determination results of whether the pixel of interest is the ship candidate pixel or not, for each pixel of interest, and
a ship pixel detection process of detecting the pixel corresponding to the ship, based on integration results obtained for each pixel of interest in the integration process.

12. The non-transitory computer-readable recording medium according to claim 11, wherein the ship detection program causes the computer to execute:
in the ship candidate pixel derivation process, calculating a pixel value statistic of the target cell and a pixel value statistic of the background cell, for each combination of the cell size of the target cell and the cell size of the guard cell, and determining whether the pixel of interest is the ship candidate pixel or not, based on a relationship between the pixel value statistic of the target cell and the pixel value statistic of the background cell, for each pixel of interest.

13. The non-transitory computer-readable recording medium according to claim 11, wherein the ship detection program causes the computer to execute:
a constant false alarm rate process of detecting the ship candidate pixel from the synthetic aperture radar image, based on a relationship between a sea surface scattering model of electromagnetic wave and a predetermined false alarm rate.

14. The non-transitory computer-readable recording medium according to claim 12, wherein the ship detection program causes the computer to execute:
a constant false alarm rate process of detecting the ship candidate pixel from the synthetic aperture radar image, based on a relationship between a sea surface scattering model of electromagnetic wave and a predetermined false alarm rate and
wherein in the ship candidate pixel derivation process, the pixel value statistic of the background cell are calculated, while excluding the pixel detected as the ship candidate pixel in the constant false alarm rate process.

15. The non-transitory computer-readable recording medium according to claim 11, wherein the ship detection program causes the computer to execute:
in the integration process, integrating the plurality of determination results of whether the pixel of interest is the ship candidate pixel or not, by counting a number of times that the pixel of interest is determined to be the ship candidate pixel, for each pixel of interest.
